(19) United States
(12) Patent Application Publication
(10) Pub. No.: US 2011/0142028 A1
(43) Pub. Date: Jun. 16, 2011

(54) SYNCHRONIZATION VIA ADDITIONAL BEACON TRANSMISSION

(75) Inventors: Mika KASSLIN, Espoo (FI); Mikko TIRRONEN, Helsinki (FI); Kari LEPPÄNEN, Helsinki (FI); Sami VIRTANEN, Espoo (FI); Enrico RANTALA, Iittala (FI); Markku TURUNEN, Helsinki (FI)

(73) Assignee: Nokia Corporation, Espoo (FI)

(21) Appl. No.: 12/635,086

(22) Filed: Dec. 10, 2009

(51) Int. Cl. H04J 3/06

(52) U.S. Cl. 370/350

(57) ABSTRACT

Apparatuses may stay synchronized with a wireless network utilizing a diluted beacon interval that is an integer multiple of a network beacon period signal being transmitted at a set interval. Diluted beacon intervals may reduce communication burden, but may also cause periods of inactivity that allow apparatuses to become unsynchronized with the network. Apparatuses may be active in the network during an awake window wherein a beacon may be transmitted. A set time may also be set during the awake window may delineate a period of time after which any beacon signal received from another apparatus is deemed to be late. Receiving late beacon signals in the apparatus may trigger the transmission of additional beacon signals to help the other apparatuses that transmitted late beacons become resynchronized with the network.

### BACKGROUND

1. Field of Invention

Embodiments of the present invention pertain to wireless communication, and in particular, to communicating network synchronization information to non-network apparatuses.

2. Background

Wireless communication has evolved from being a means for verbal information to being more focused on total digital interactivity. Enhancements in wireless technology have substantially improved communication abilities, quality of service (QoS), speed, etc., which has contributed to an insatiable desire for new device functionality. As a result, portable wireless apparatuses are no longer just tasked with making telephone calls. They have become integral, and in some cases essential, tools for managing the professional and/or personal life of users.

In order to support the desired expansion of electronic communication, more and more applications that did not incorporate any communication functionality are being redesigned to support wired and/or wireless communication. Such wireless communication support may, in some instances, include the ability to send monitored or observed data to other apparatuses via wireless communication. Example usage scenarios may include natural resource monitoring, biometric sensors, systems for supporting financial transactions, personal communication and/or location devices, etc. Apparatuses such activities and subsequent communications often operate using limited resources. For example, these apparatuses may be simple (e.g., may have limited processing resources), may be small (e.g., may have space constraints due to size limitations imposed in retrofit applications), may have power constraints (e.g., battery powered), etc.

Link establishment and maintenance processes defined in existing communication protocols may not be appropriate for apparatuses operating with resource constraints such as set forth above. For example, standards for existing wireless communication protocols may require periodic interaction in order to keep apparatuses participating in the network synchronized with other apparatuses. These requirements may not take into consideration the burden that periodic network communication places upon resource-constrained devices. As a result, it may become difficult to operate such resource-constrained apparatuses in accordance with these standards.

### SUMMARY

Example embodiments of the present invention may be directed to a method, apparatus, computer program and system for facilitating apparatus interaction while conserving apparatus resources. In accordance with at least one example implementation, apparatuses may stay synchronized with a network utilizing a reduced or diluted beacon interval that is an integer multiple of a network beacon period signal being transmitted at a set interval. Diluted beacon intervals may the reduce communication burden for apparatuses since the need to communicate occurs less frequently. However, as periods of inactivity increase during diluted beacon intervals it becomes easier for apparatuses to slip out of synchronization with the timing of the network.

In accordance with at least one embodiment of the present invention, solutions are provided in order to allow apparatuses to resynchronize with a wireless network. Apparatuses may be active in the network in accordance with an awake window. During an awake window an apparatus may transmit a beacon and then enter into an empty queue state (e.g., no data still pending for transmission) or non-empty queue state (e.g., data still pending for transmission). Concurrently with these operations, a set time during the awake window may delineate a period of time after which any beacon signal received from another apparatus is deemed to be late. Receiving late beacon signals in an apparatus may trigger the apparatus to perform various operations that may help bring apparatuses that issued late beacons back into synchronization.

For example, apparatuses that receive late beacon signals may transmit additional beacon signals in order to assist other apparatuses realign to the network beacon signal interval, or alternatively to a diluted beacon interval based on an integer multiple of the network beacon signal interval. Apparatuses in a non-empty queue state may first transmit pending data before attempting to transmit an additional beacon. Apparatuses may then participate in contention in the network for communication access. Once access to the communication channel is granted, the apparatus may transmit an additional beacon and then return to the non-empty queue state. Only one additional beacon signal may be transmitted by an apparatus in an awake state period.

The above summarized configurations or operations of various embodiments of the present invention have been provided merely for the sake of explanation, and therefore, are not intended to be limiting. Moreover, inventive elements associated herein with a particular example embodiment of the present invention can be used interchangeably with other example embodiments depending, for example, on the manner in which an embodiment is implemented.

### DESCRIPTION OF DRAWINGS

The disclosure will be further understood from the following description of various exemplary embodiments, taken in conjunction with appended drawings, in which:

FIG. 1 discloses examples of hardware and software resources that may be utilized when implementing various example embodiments of the present invention.

FIG. 2 discloses an example network environment in accordance with at least one example embodiment of the present invention.

FIG. 3 discloses examples of various types of messaging that may be utilized in accordance with at least one example embodiment of the present invention.

FIG. 4 discloses an example of inter-apparatus message propagation, which may result in distributed local web formation, in accordance with at least one example embodiment of the present invention.

FIG. 5 discloses example beacon implementations that are usable in accordance with at least one example embodiment of the present invention.

FIG. 6 discloses an example of awake windows in accordance with at least one example embodiment of the present invention.

FIG. 7 discloses examples of access control strategies in accordance with at least one example embodiment of the present invention.

FIG. 8 discloses a potential impact of extended sleep periods on apparatuses that are operating using a diluted beacon period in accordance with at least one example embodiment of the present invention.

FIG. 9A discloses an example of corrective operations that may be implemented, in accordance with at least one example embodiment of the present invention, when late beacons are received in an apparatus that already has data pending for transmission.

FIG. 9B discloses an alternative example of corrective operations that may be implemented, in accordance with at least one example embodiment of the present invention, when late beacons are received in an apparatus that already has data pending for transmission.

FIG. 9C discloses examples of corrective operations that may be implemented, in accordance with at least one example embodiment of the present invention, when late beacons are received in an apparatus that has no data pending for transmission.

FIG. 10 discloses a flowchart for an example late beacon reception and additional beacon transmission process in accordance with at least one example embodiment of the present invention.

### DESCRIPTION OF EXEMPLARY EMBODIMENTS

While the present invention has been described herein in terms of a multitude of example embodiments, various changes or alterations can be made therein without departing from the spirit and scope of the present invention, as set forth in the appended claims.

### I. General System With Which Embodiments of the Present Invention May Be Implemented

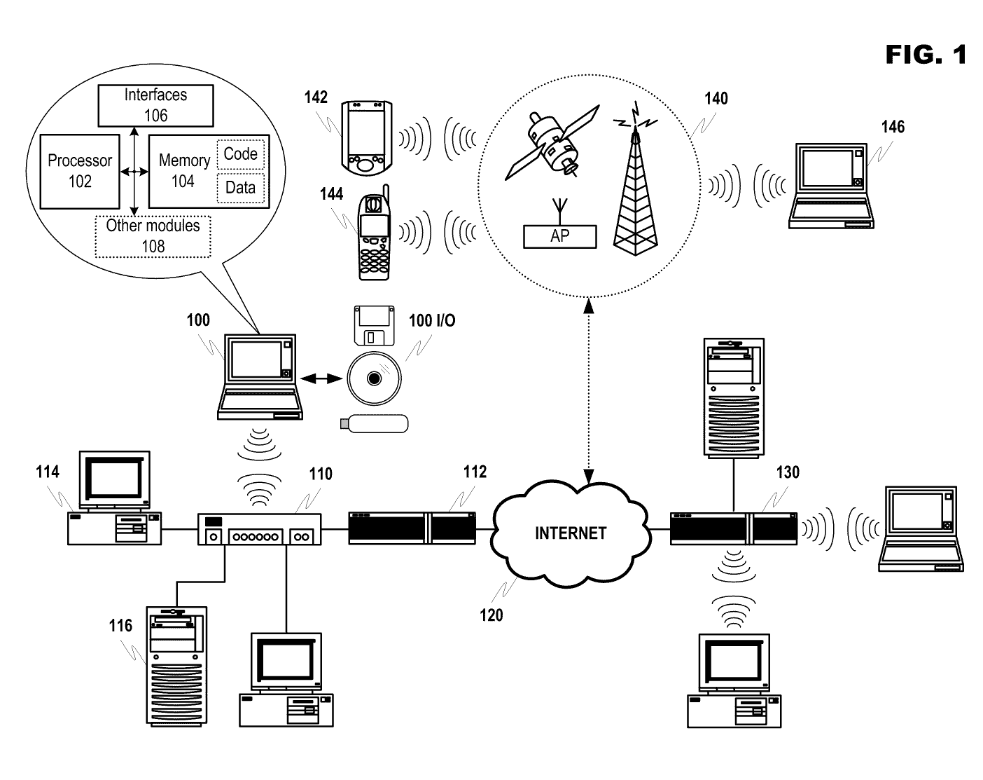

An example system usable as a basis for explaining the various embodiments of the present invention is disclosed in FIG. 1. The apparatuses and configurations shown in FIG. 1 are merely representative, and thus, may be included in, or omitted from, actual implementations.

Computing device 100 may correspond to various processing-enabled apparatuses including, but not limited to, micro personal computers (UMPC), netbooks, laptop computers, desktop computers, engineering workstations, personal digital assistants (PDA), computerized watches, wired or wireless terminals/nodes/etc., mobile handsets, set-top boxes, personal video recorders (PVR), automatic teller machines (ATM), game consoles, or the like. Elements that represent basic example components comprising functional elements in computing device 100 are disclosed at 102-108. Processor 102 may comprise one or more components configured to execute instructions, for instance, wherein a group of instructions may constitute program code. In at least one scenario, the execution of program code may include receiving input information from other elements in computing device 100 in order to formulate an output (e.g., data, event, activity, etc). Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired and/or wireless bus. For example, processor 102 may access memory 102 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Examples of removable storage media based on magnetic, electronic and/or optical technologies are shown at 100 I/O in FIG. 1, and may serve, for instance, as a data input/output means. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks also shown in FIG. 1. For example, communication hub 110 may provide wired and/or wireless support to devices such as computer 114 and server 116. Communication hub 110 may also be coupled to router 112, allowing devices in the local area network (LAN) to interact with devices on a wide area network (WAN, such as Internet 120). In such a scenario, another router 130 may transmit information to, and receive information from, router 112 so that devices on each LAN may communicate. Further, all of the components depicted in this example configuration are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may interact with computing device 100 over Internet 120 as facilitated by wireless communication 140. Similar functionality may be also be included in other apparatuses, such as laptop computer 146, in the form of hardware and/or software resources configured to allow short and/or long range wireless communication.

### II. Example Networking Environment

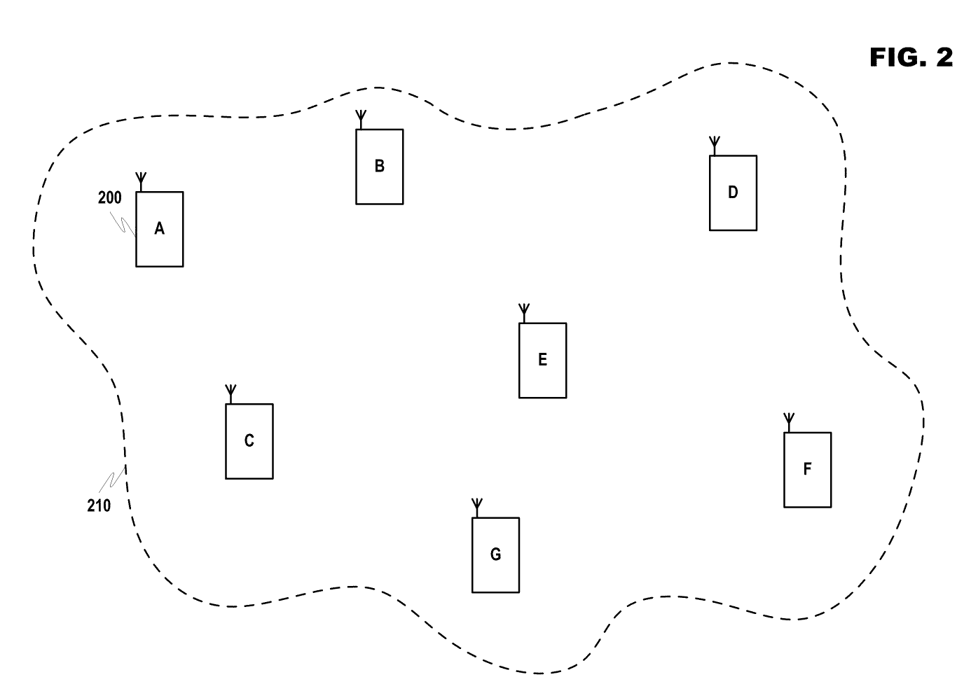

FIG. 2 discloses an example of an operational space that will be used to explain the various example embodiments of the present invention. As this example scenario is utilized herein only for the sake of explanation, implementations of the present invention are not limited specifically to the disclosed example. Operational spaces may be defined using different criteria. For example, physical areas like buildings, theatres, sports arenas, etc. may define a space where users may interact. Alternatively, operational spaces may be defined in terms of apparatuses that utilize particular wireless transports, apparatuses that are within communication range (e.g., a certain distance) of each other, apparatuses that are members of certain classes or groups, etc.

Wireless-enabled apparatuses 200 are labeled “A” to “G” in FIG. 2. Apparatuses 200 may, for example, correspond to any of the wireless-enabled apparatuses that were disclosed in FIG. 1, and may further include at least the resources discussed with respect to apparatus 100. These apparatuses may further operate utilizing at least one common wireless communication protocol. That is, all of the apparatuses disclosed in FIG. 2 may interact with each other within the operational space, and thus, may participate together in a wireless communication network.

### III. Examples of Messaging

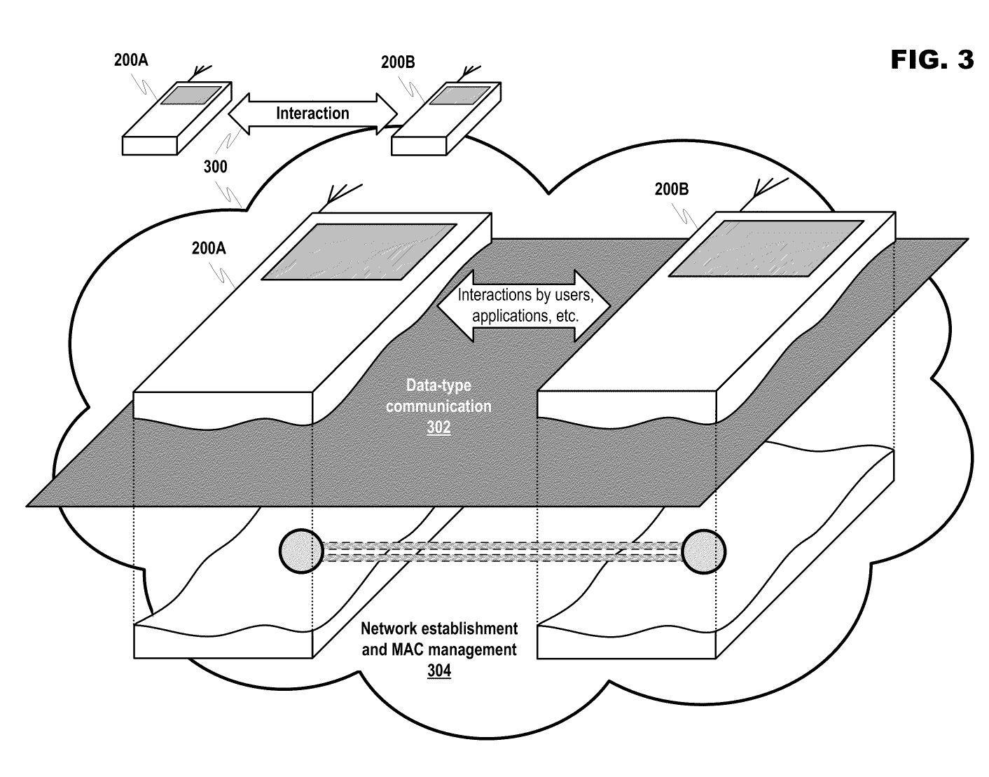

An example communication between apparatuses in accordance with at least one embodiment of the present invention is disclosed at 300 in FIG. 3. While only two apparatuses 200A and 200B are shown, the example disclosed in FIG. 3 has been presented for explanation only, and is not intended to limit the scope of the present invention. Various embodiments of the present invention may readily facilitate wireless interaction between more than two apparatuses.

Additional detail with respect to communication example 300 is disclosed further in FIG. 3. Apparatus 200A may have communication requirements that require interaction with apparatus 200B. For example, these requirements may comprise interactions by apparatus users, applications residing on the apparatuses, etc. that trigger the transmission of messages that may be generally classified under the category of data-type communication 302. Data-type communication may be carried out using messages that may be wirelessly transmitted between apparatus 200A and 200B. However, typically some form of wireless network link or connection needs to be established before any data type communication messages 302 may be exchanged.

Network establishment and media access control (MAC) management messages 304 may be utilized to establish and maintain an underlying wireless network architecture within an operating space that may be utilized to convey data type communication messages 302. In accordance with various example embodiments of the present invention, messages containing apparatus configuration, operation and status information may be exchanged to transparently establish wireless network connections when, for example, an apparatus enters an operating space. Network connections may exist between any or all apparatuses existing within the operating space, and may be in existence for the entire time that an apparatus resides in the operating space. In this way, data-type communication messages 302 may be conveyed between apparatuses using existing networks (new network connections do not need to be negotiated each time messages are sent), which may reduce response delay and increase quality of service (QoS).

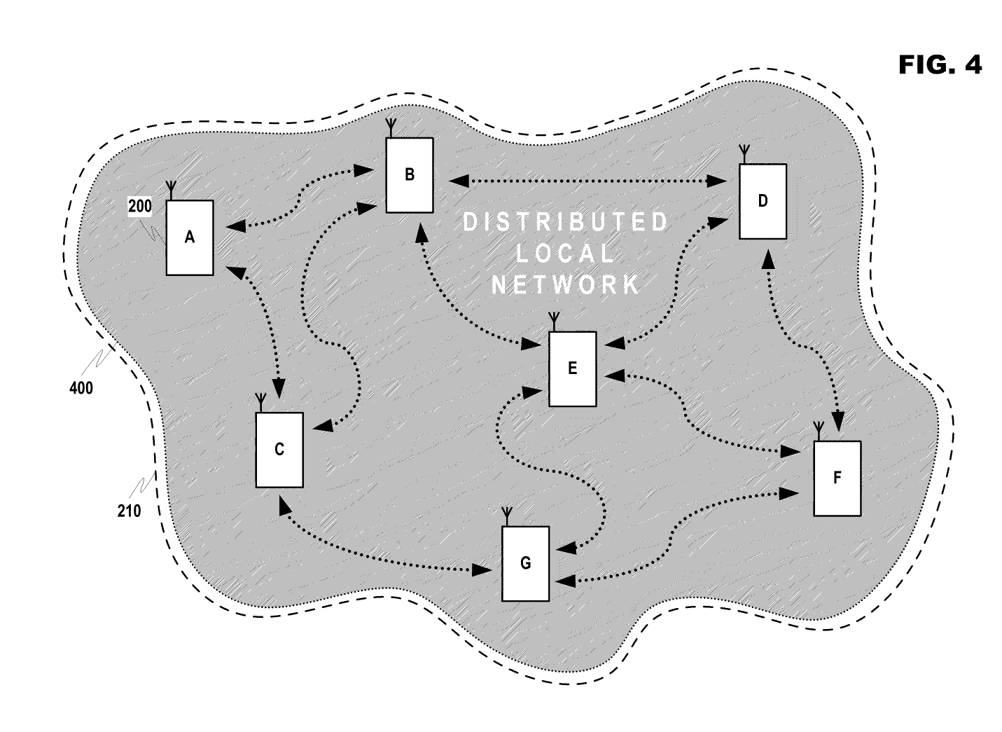

In accordance with at least one embodiment of the present invention, an example of distributed local network formation via automated network establishment and MAC management messages 304 is disclosed in FIG. 4. Apparatuses 200 entering into operational space 210 may immediately initiate network formation through the exchange operational information. Again, the exchange of this information may occur without any prompting from, or even knowledge of, a user. Example interactivity is shown in FIG. 4, wherein various network establishment and MAC management messages 304 are exchanged between apparatuses A to G. In accordance with at least one example embodiment of the present invention, messages may be exchanged directly between an originating apparatus (e.g., the apparatus that is described by information elements contained in a message) and a receiving apparatus. Alternatively, messages corresponding to apparatuses in operational space 210 may be forwarded from one apparatus to another, thereby disseminating the information for multiple apparatuses.

### IV. Example Operational Parameter: Diluted Beacon Period

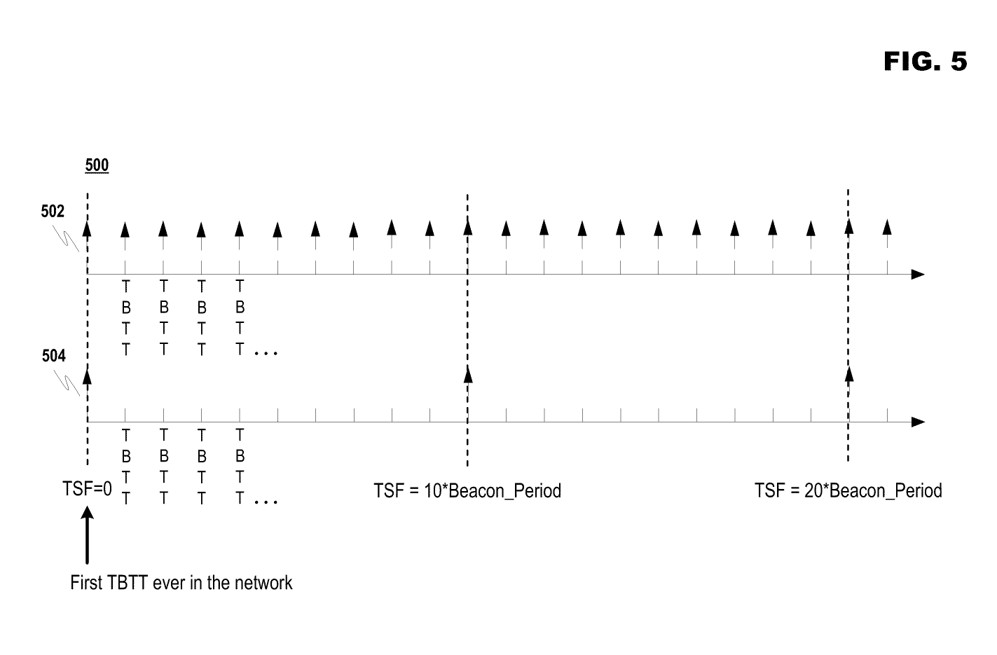

An example of information that may be communicated in network establishment and MAC management messages 304 (e.g., using information elements), in accordance with at least one example embodiment of the present invention, is disclosed in FIG. 5. The activity flow disclosed at 500 represents an example implementation based on the wireless local area networking (WLAN) standard, as defined in the IEEE 802.11 specification. However, embodiments of the present invention are not limited only to implementation with WLAN, and thus, may be applied to other wireless network architectures or communication protocols.

The WLAN logical architecture comprises stations (STA), wireless access points (AP), independent basic service sets (IBSS), basic service sets (BSS), distribution systems (DS), and extended service sets (ESS). Some of these components map directly to hardware devices, such as stations and wireless access points. For example wireless access points may function as bridges between stations and a network backbone (e.g., in order to provide network access). An independent basic service set is a wireless network comprising at least two stations. Independent basic service sets are also sometimes referred to as an ad hoc wireless network. Basic service sets are wireless networks comprising a wireless access point supporting one or multiple wireless clients. Basic service sets are also sometimes referred to as infrastructure wireless networks. All stations in a basic service set may interact through the access point. Access points may provide connectivity to wired local area networks and provides bridging functionality when one station initiates communication to another station or with a node in a distribution system (e.g., with a station coupled to another access point that is linked through a wired network backbone).

In wireless network architectures like WLAN, beacon signals may be utilized to synchronize the operation of networked apparatuses. In situations where new ad hoc networks are being created, the initiating apparatus may establish standard network beaconing based on it owns clock, and all apparatuses that join the network may conform to this standard beacon. Similarly, apparatuses that desire to join an existing wireless network may synchronize to the existing beacon. In the case of WLAN, apparatuses may synchronize to beacon signals utilizing a timing synchronization function (TSF). The timing synchronization function is a clock function that is local to an apparatus that synchronizes to and tracks the beacon period.

An example of a beacon signal is shown in FIG. 5 at 502 wherein a target beacon transmission time (TBTT) indicates the targeted beacon transmission. This time may be deemed “targeted” because the actual beacon transmission may be a somewhat delayed from the TBTT due to, for example, the channel being occupied at TBTT. The apparatuses that are active in the network may communicate with each other in accordance with the beacon period (time between two beacon transmissions). However, there may be instances where it may not be beneficial, and may possibly even be detrimental, for apparatuses to be active during each beacon period. For example, apparatuses that do not expect frequent communication within the wireless network may not benefit from being active for every beacon period. Moreover, apparatuses with limited power or processing resource may be forced to waste these precious resources by the requirement of being active for every beacon period.

In accordance with at least one embodiment of the present invention, functionality may be introduced utilizing the example distributed wireless network described above to allow apparatuses to operate at a standard beaconing rate that has been established in the network, or alternatively, using a “diluted” beaconing rate. “Diluted” beaconing may comprise a beaconing mode operating at a lower frequency than the standard beaconing rate originally established in the network. Diluted beaconing may be based on information (e.g., information elements) that is included in network beacon frames, wherein the included information may express one or more diluted beacon rates as multiples of the beacon. Using the beacon and the one or more associated diluted beacon period indications contained within beacon frames, networked apparatuses may elect to operate (e.g., via random contention) based either on the standard beacon or a diluted beacon period. In particular, all apparatuses may synchronize to the same initial target beacon transmission time (TBTT), for example when TSF=0, and may then count the number periods that occur after the initial TBTT based on the internal TSF function. In this way, apparatuses operating using a diluted beacon period may be active on TBTT counts that corresponds to the multiple defined by the diluted beaconing period.

An example diluted beacon interval of every 10^{th} TBTT is disclosed in FIG. 5 at 504. The decision on a beacon interval to utilize may be handled by each apparatus individually, (e.g., in the protocol stacks that manage operation of a radio modem). All apparatuses will then, in accordance with at least one embodiment of the present invention, operate based on a beacon interval that remains the same for the lifetime of the network. In view of the requirement that the beacon interval remain unchanged for the duration of the wireless network, the diluted beacon signal may be expressed as a multiple of the beacon signal. Starting intervals may be defined by the apparatus that formed the network, and in the example disclosed in FIG. 5 (and as previously set forth) the first TBTT is equivalent TSF=0. Other apparatuses that subsequently join the network may adopt this beacon interval parameter and TBTT timing. For example, the TBTT at TSF=0 is the “base point” that determines when beacons are transmitted. All the devices in the network may update their own TSF counters as per legacy synchronization rules, and from the TSF they may determine the particular TBTT in which to participate in beaconing assuming that, regardless of the beacon interval, the first beacon was transmitted at TSF=0.

For example, in a network comprising four apparatuses where devices 1, 2 and 4 operate using a diluted beaconing mode having a beacon interval (e.g., a time period between beacon transmissions) of every 6^{th} TBTT, all apparatuses may remain synchronized even though only device 3 may be active (e.g., “competing”) in all beaconing periods 1, 2, 3, 4 and 5 (e.g., all apparatuses may participate in TBTT 0, TBTT 6, TBTT 12, etc.) Therefore, there can be at least two different beacon periods among the apparatuses, and possibly further diluted beacon periods as other groups of apparatuses may have selected their own diluted beaconing period based on the original beaconing period and the one or more associated diluted beacon period indications transmitted therewith.

In accordance with at least one example embodiment of the present invention, beacons will contain a diluted beacon period parameter. The diluted beacon period parameter may, for example, be carried in vendor-specific information elements (IEs). Diluted beacon period parameter values may remain the same for the lifetime of the network. However, should there be need for more flexibility, other beacon intervals may be defined, and all of the defined beacon intervals may be signaled in a manner similar to the diluted beacon interval.

### V. Examples of Awake Windows

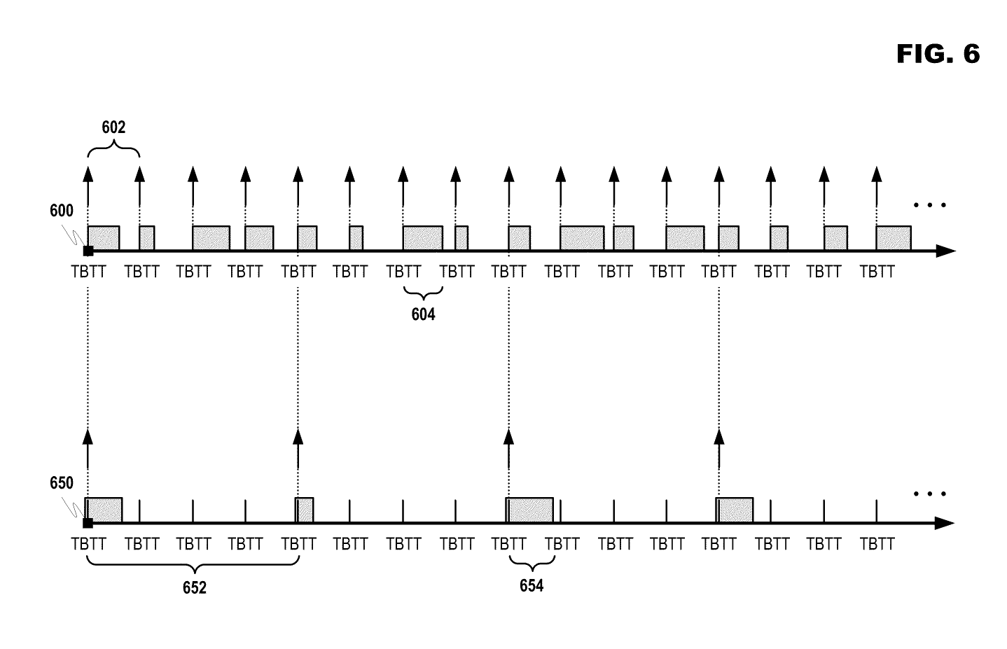

FIG. 6 discloses an example implementation of “awake windows” in accordance with at least one embodiment of the present invention. Similar to FIG. 5, a “standard” network beacon (e.g., the beacon established by the apparatus that formed the network) is shown at 600. Each target beacon transmit time (TBTT) may represent a beacon frame that is transmitted by an apparatus in the network (or at least times at which beacon transmissions were targeted, barring any delays). Thus, the interval shown at 602 may therefore define the standard beacon period.

Possible awake windows for an apparatus that is participating in the network are further shown in FIG. 6, an example of which is identified at 604. These active periods occur in accordance with each transmitted TBTT, and therefore, may be deemed aligned with the normal network beacon period. These awake windows do not necessarily represent that an apparatus has planned activity (e.g., messages queued for transmission) during these time periods. On the contrary, they are merely periods of time when apparatuses may be active, and therefore, will be able to transmit messages to, and/or receive messages from, other apparatuses in the network.

The behavior of another example apparatus in accordance with at least one embodiment of the present invention is further disclosed at 650. While all apparatuses in the network will operate based on the same origin point (e.g., TSF=0) and normal beacon period (e.g., as set forth by the TBTT), each apparatus may select an operational mode based upon the one or more diluted beacon period indications that are transmitted in the beacon. For example, the apparatus corresponding to the activity disclosed at 650 is operating utilizing diluted beacon period 652, which is a multiple “4” in this scenario. Therefore, diluted beacon period 652 may involve beacon transmissions per every four TBTTs. Awake windows, for example as shown at 654, may also occur in accordance with the diluted beacon period 652. In at least one example implementation, the awake windows may begin just prior to the commencement of the diluted beacon period.

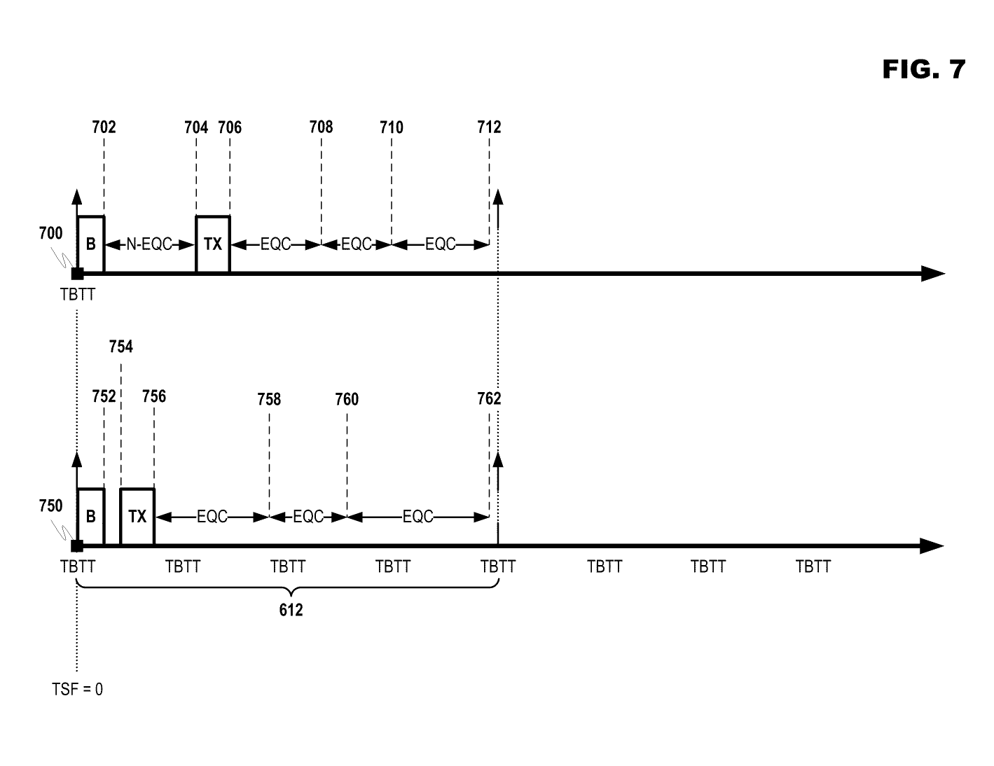

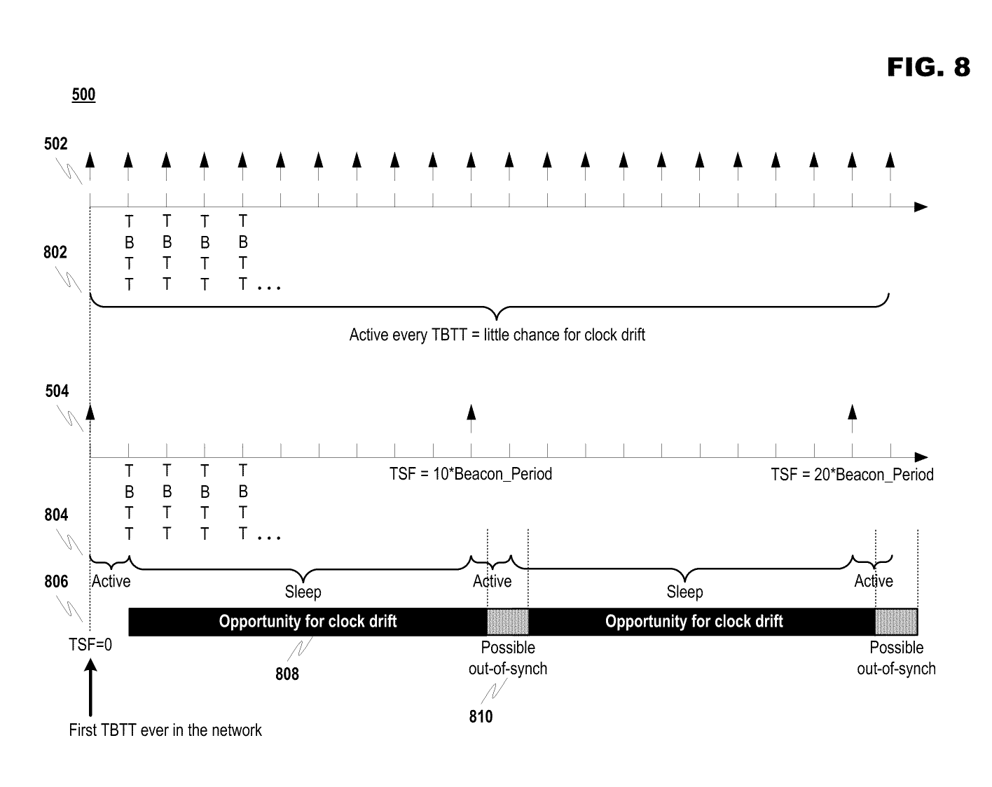

The duration of awake windows, while configured at constant duration by a predetermined information element (IE) in the beacon, may end up being variable in actual practice. For example, the awake window may be based on a MAC parameter that is similar to the beacon interval and diluted beacon period parameters. A host in the beaconing apparatus may determine it and provides it to the modem for transmission in the beacon. It may be communicated using, for example, a general or vendor specific information element (IE) as with the beacon interval and diluted beacon period. Upon awake window expiration apparatuses may attempt to transition to a “doze” or sleep state. However, the transition to doze state may, in actuality, happen earlier or later in accordance with control methodologies that will be discussed with respect to FIG. 7-8.

FIG. 7 discloses channel access control configurations that may be implemented in accordance with at least one embodiment of the present invention. Initially two channel access states may be defined: a non-empty queue contention (N-EQC) state and an empty queue contention (EQC) state. When apparatuses have no messages (frames) queued for transmission in transmit buffers, the device may be deemed in an EQC state. Alternatively, apparatuses may be deemed in an N-EQC state when there is at least one frame awaiting transmission.

The N-EQC state may comprise optional implementations: “Legacy” 700 and “Beacon Prioritized” 750. Using Legacy implementation 700, upon receiving or transmitting a beacon channel contention may be executed as in legacy devices, for example, as defined by the channel access rules specified in the particular wireless communication medium. Legacy implementation 700 represents an example of channel contention in accordance with an existing set of access control rules between 702 and 704. Once the apparatus gains access to media at 704 it will obtain a transmission opportunity (TXOP) during which it may transmit frames to the network (e.g., if one or more frames are queued for transmission. “TX” as shown between 704 and 706 in FIG. 7 represents the transmission of any queued messages. Further, frames may be received from the network as acknowledgements to the transmitted frames in the “TX” period.

In Beacon Prioritized implementation 750, the apparatus that has transmitted the network beacon is permitted to continue transmitting any frames that are queued for transmission in its transmit buffers. The apparatus obtains a TXOP for beacon transmission, and once it has transmitted the beacon at 752 it may automatically obtain a new TXOP, as shown at 754, to transmit any frames that are pending in its transmit buffers. In the disclosed example the new TXOP may start after a short interframe space (SIFS) period following the end of the beacon frame, which is represented in example 750 by the space shown between 752 and 754.

Once the apparatus has completed transmission (e.g., emptied its transmission buffers), it shall enter into an EQC state as shown in implementations 700 and 750 at 706 and 756, respectively. If an apparatus has no frames for transmission during a beacon interval, the device transition directly into an EQC state after the beacon reception/transmission (e.g., at 702, 752). When in the EQC state apparatuses may try to obtain a TXOP for a given number of times (determined, for example, by a “RepeatEmptyQueueContention” parameter). Upon obtaining a TXOP, apparatuses without pending messages may attempt to obtain a new TXOP as shown at 708/710 and 758/760 in implementations 700 and 750, respectively, instead of initiating the transmission of a frame sequence. Devices that obtain a number of TXOPs that is equal to a predetermined threshold value (e.g., RepeatEmptyQueueContention times) during a beacon interval may enter into doze or sleep state. In example implementations 700 and 750 in FIG. 7 this may occur at 712 and 762, respectively. All of these events may happen before awake window 612 expires. Moreover, example legacy implementation 700 and example beacon prioritized implementation 750 both assume that the message transmissions between 704 and 706, as well as 754 and 756, respectively, succeed, and thus, no frames are pending for (re)transmission beyond this point.

### VI. Potential Clock Caused by Extended Sleep Periods.

The operational example that was originally disclosed in FIG. 5 is analyzed from a different perspective in FIG. 8. For example, some apparatuses may be active for every TBTT as disclosed at 502. This constant operation, while somewhat resource intensive, keeps these apparatuses in constant communication with the network, and thus, in synchronization with the timing of the network. This beneficial effect of constant communication is disclosed at 802. Example operation in accordance with a diluted beacon interval is also disclosed in FIG. 8 at 504. As previous set forth, apparatuses may realize resource savings by only being active in a network based on an integer multiple of the network beacon signal interval. Resources may be conserved when using this mode of operation because apparatuses may enter an inactive state (e.g., enter a sleep mode) in between each TBTT in the diluted beacon interval as shown at 804.

However, the example disclosed in FIG. 8 also shines light on potential problems 806 that may occur for apparatuses operating in accordance with a diluted beacon period. Sleep periods such as disclosed at 804 may create relatively long durations where apparatuses are out of communication with the network. It is foreseeable that during these extended sleep period that the timing of apparatuses may drift with respect to the network timing as shown at 808. As a result, these apparatuses may become active at a time that is not aligned with expectations such as shown at 810. In particular, apparatuses within the network may transmit messages to out-of-synch apparatuses, and the latter apparatuses may miss receiving these messages because they are not active at the correct time. The opposite situation may also occur where the out-of-synch apparatus transmits messages during instances when other apparatuses are inactive. The ultimate impact may be a disruption in communication causing an overall drop in quality of service (QoS) and a possible expenditure of additional apparatus resources in order to retransmit messages, etc.

### VII. Example Operations for Additional Beacon Transmissions.

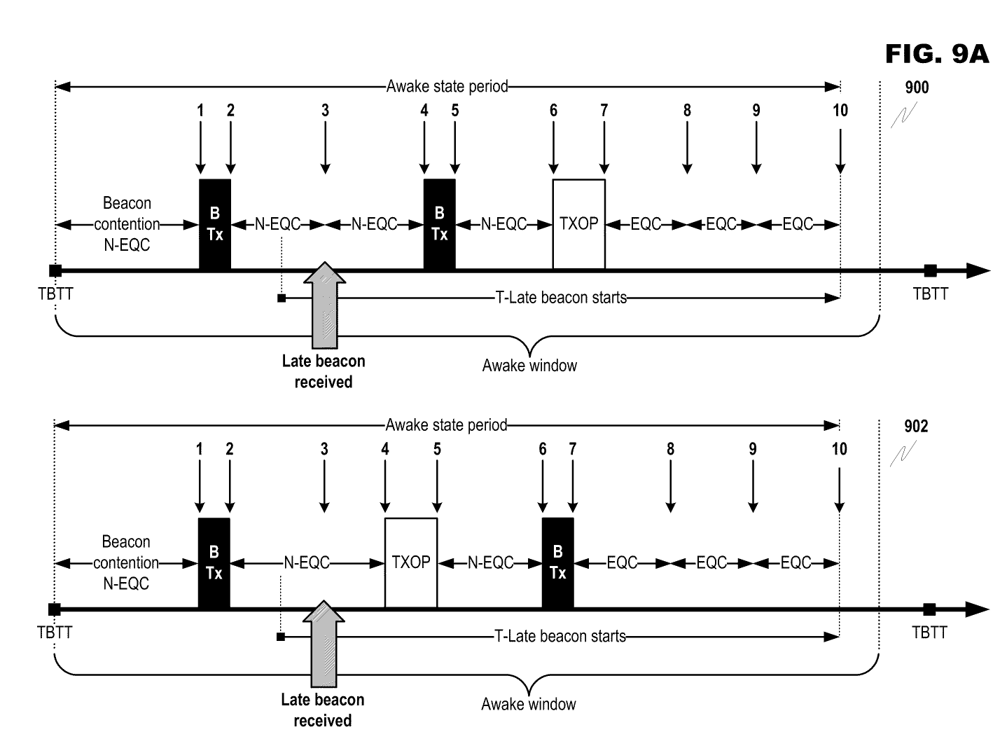

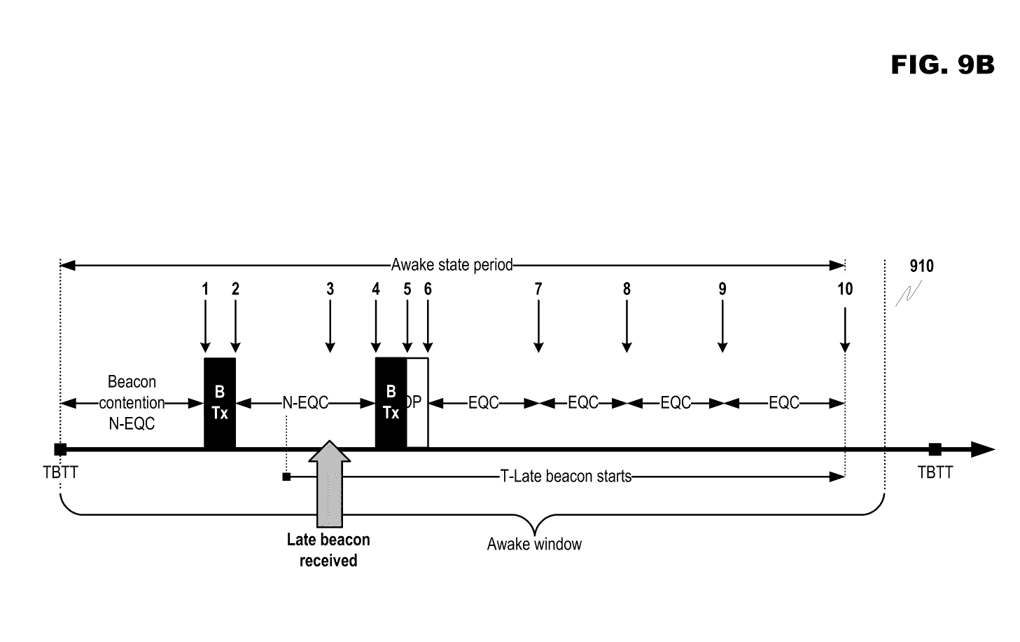

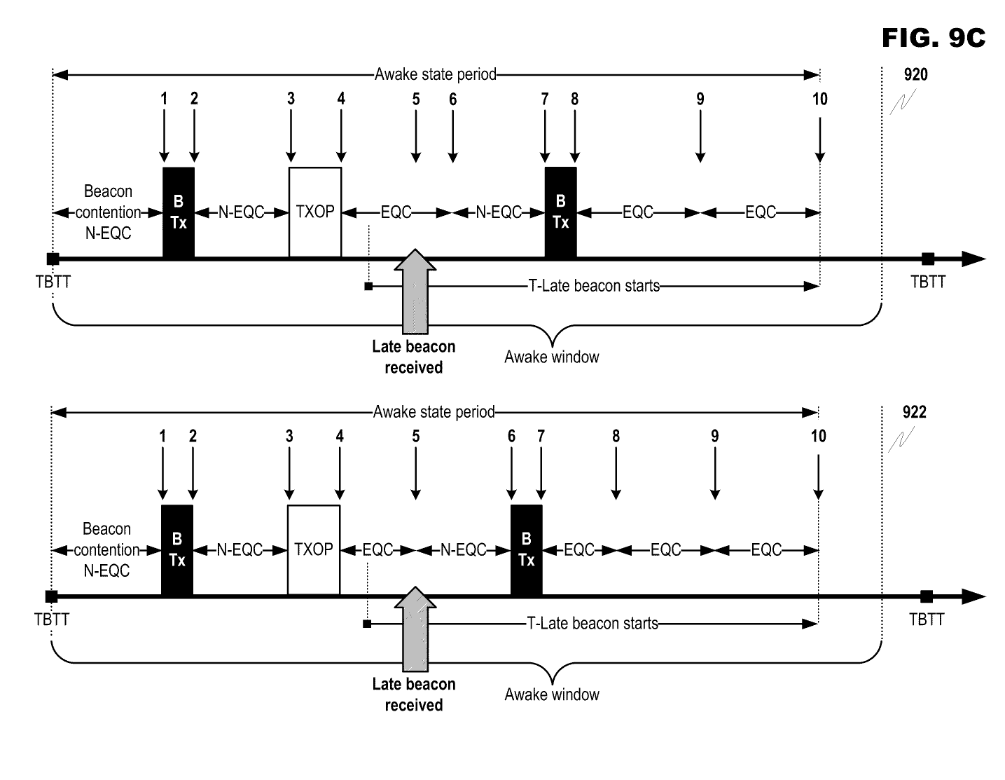

In accordance with at least one embodiment of the present invention, operations that may help bring apparatuses back into synchronization with a network beacon signal interval are disclosed in FIG. 9. For example, apparatuses that receive beacon signals from within their own network (e.g., having the same network identifier) at exceptionally late instances during an awake window may be indicative of a situation where the apparatus from which the late beacon was received has not received (at least recently) any beacons from the network, and thus, may lose synchrony with the network. This may especially be true if the late beacon doesn't invoke TSF timer update routines in the receiving apparatus (e.g., the timestamp value in a beacon that was received late is earlier than the receiving device's own TSF timer). In accordance with at least one embodiment of the present invention, the receipt of such a late beacon may trigger apparatuses to begin access contention for beacon transmission (e.g., an additional beacon) in order to have a synchronization information provided to the late beaconer. Such a conditional beacon may be transmitted only by apparatuses that have already transmitted a beacon during the current awake state period. It therefore becomes more probable that late beaconing apparatuses may receive additional beacons rather than a scenario where all of the neighboring apparatuses simultaneously attempt to contend for channel access in order to transmit another beacon signal.

Activity charts that exemplify events that may occur in accordance with various example implementations of the present invention are disclosed in FIG. 9A-C. Initially, a time limit (Tlate_beacon), which may be defined as a time occurring after the TBTT that initiated the awake window, may be established after which received network beacon signals corresponding to the network of the receiving apparatus are considered late beacons. If apparatuses in the network have transmitted beacon signals during the current awake state period, and these apparatuses then receive beacon signals from their own network (e.g., having the same network identifier) after Tlate_beacon, the receiving apparatus may start contending for another beacon transmission. A maximum one additional beacon will be transmitted by any device. Example criteria that may trigger additional beacon transmission may comprise, but is not limited to, a received beacon containing a Timestamp value that indicates that the apparatus that transmitted the beacon is in risk of dropping out of synchrony with the network (e.g., the TSF time in the receiving apparatus at the time a beacon was received−timestamp of the received beacon>a difference that may cause synchronization to be lost). Another example scenario that may trigger an additional beacon transmission is when a received beacon does not cause a receiving apparatus to adjust its own TSF timing (i.e. the TSF time in the receiving apparatus at the time the beacon was received≧timestamp of the received beacon, so that the sending apparatus appears to be running behind).

The setting for Tlate_beacon may depend upon network characteristics and radio environment, and thus, it may be an adjustable parameter. Apparatuses may need to be able to adjust Tlate_beacon on fly during the operation of the network. Therefore, each apparatus in the network may determine the most appropriate value based on an assessment of the environment in which the network is operating. The value should be set so that a substantial amount (e.g., 95%) of all the beacons in the network are transmitted before the Tlate_beacon is exceeded. A late beacon then becomes a rare case and a real indication of some problems in the beaconing device.

A course of events that may occur when an apparatus receives a late beacon while still having data pending for transmission is disclosed in FIG. 9A. In activity flow 900, which is further subdivided into numerals 1-10, an apparatus may participate in network access contention in order to obtain permission to transmit a beacon signal. A beacon signal may be transmitted if an apparatus has been granted access and a beacon from another apparatus in the network has not already been received. The apparatus may then be deemed in an N-EQC state since a message (e.g., a beacon signal) is pending for transmission. Upon the grant of permission to transmit, the apparatus may then transmit a beacon signal between 900-1 and 900-2. The apparatus may then enter an N-EQC state in order to contend for permission to transmit pending messages when a late beacon signal is received at 900-3. The receipt of a late beacon signal may interrupt the ongoing N-EQC state corresponding to the pending messages and may initiate an N-EQC state for transmission of an additional beacon signal. The additional beacon signal may be transmitted between 900-4 and 900-5, which may be followed by an N-EQC state for requesting a transmit opportunity (TXOP) during which any pending messages may then be transmitted (e.g., between 900-6 to 900-7). The apparatus may determine times 900-8, 900-9 and 900-10 to enter into a doze (e.g., low power) state. While the disclosed awake state period ends at 900-10, termination of the full awake window does not occur until later, which ends the current beaconing period.

FIG. 9A also discloses alternative activity flow 902, which comprises events similar to those described above with respect to activity flow 900. However, in activity flow 902 the receipt of the late beacon signal at 902-3 does not interrupt the ongoing access contention so that the apparatus may transmit pending messages at 902-4. The TXOP period granted to the apparatus may be complete at 902-5, at which point the apparatus may reenter contention in order to transmit an additional beacon signal between 902-6 and 902-7. Subsequent EQC periods may follow at 902-8 and 902-9 until the awake state period is concluded at 902-10.

The example disclosed in FIG. 9B describes another possible course of operation for an apparatus when messages are already pending for transmission when a late beacon signal is received. Activity flow 910 is again similar to the example disclosed in FIG. 9A at 900 until a late beacon signal is received at 910-3. However, in the example disclosed at 910 the receipt of a late beacon signal at 910-3 does not interrupt the ongoing N-EQC state contention, and thus, the apparatus may be granted a TXOP at 910-4. The first message that may be transmitted during the TXOP may be an additional beacon signal (e.g., between 910-4 and 910-5), which may be followed by messages that were previously pending in the apparatus, until the TXOP concludes at 900-6. The apparatus may then enter a series of EQC states as shown at 910-7, 910-8 and 910-9 until the awake state period concludes at 910-10. While the example disclosed at 910 has the apparatus entering an EQC state when the TXOP concludes at 910-6, this may not always be the case. As an unplanned reception of a late beacon signal may result in the transmission of an additional beacon signal that was not anticipated when the TXOP was requested, the apparatus may not be able to process all of the messages pending for transmission during the remainder of the TXOP. Therefore, while not shown, it is possible that the apparatus may reenter an N-EQC state at the conclusion of the TXOP at 910-6 in order to transmit of any remaining messages.

Other example activity flows, in accordance with at least one embodiment of the present invention, are disclosed at 920 and 922 in FIG. 9C. However, these particular examples deal with situations where no data is pending for transmission in the receiving apparatus at the time a late beacon is received. Again, apparatuses may enter access contention in the network in order to transmit a beacon signal, the beacon actually being transmitted between 920/922-1 and 920/922-2. The apparatuses may remain in the N-EQC state so that pending data may be transmitted in accordance with the transmit opportunity (TXOP) disclosed between 920/922-3 and 920/922-4. The apparatus may be in the EQC state when a late beacon is received at 920/922-5. The two examples 920 and 922 diverge at this point. In example 920 apparatuses may complete the EQC state period at 920-6 and then start contending for permission to transmit an additional beacon once access is granted. The beacon may then be transmitted at 920-7 to 920-8. The apparatuses may then enter an EQC state and may run two EQC state contentions with the last one being completed at 920-10 when the awake state period is completed. In example 922 the apparatuses may immediately cease EQC state contention at 922-5 and initiate contention for beacon transmission until the additional beacon has been transmitted between 922-6 and 922-7. The apparatuses may then enter an EQC state to first complete the interrupted EQC contention between 922-7 and 922-8, after which it may run yet another EQC state contention at 922-9 that ends at 922-10 where the awake state period is complete.

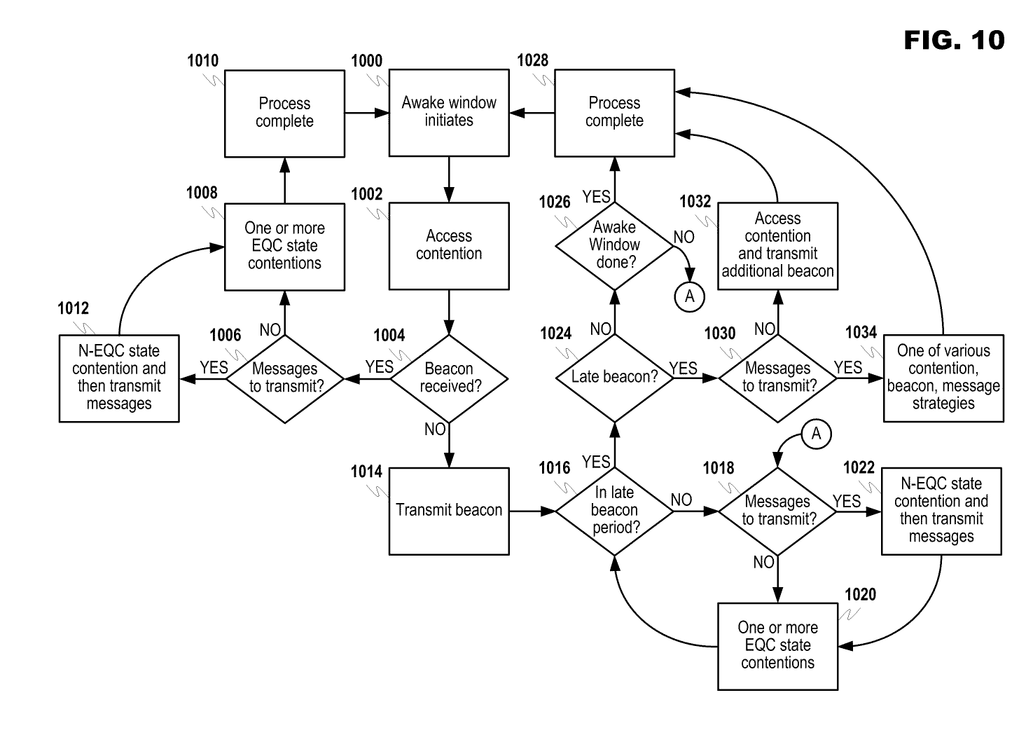

A flowchart for an example beacon transmission process, in accordance with at least one embodiment of the present invention, is disclosed with respect to FIG. 10. An awake window for an apparatus may begin in step 1000. The apparatus may then contend for access to transmit a beacon signal in step 1002, and upon being granted permission may then transmit the beacon signal at step 1012. However, the beacon transmission process may be interrupted in step 1004 if a beacon signal from another apparatus in the network is received in the apparatus. In such instances no later beacon signals may be transmitted from the apparatus. The process may then move to step 1006 where a determination may be made as to whether any messages are pending in the apparatus. If no messages are pending in the apparatus per step 1006, then the process may enter one or more empty queue contention (EQC) states in step 1008. The EQC state contentions may continue for some or all of the awake window, which may be followed by process termination in step 1010 and a return to step 1000 to prepare for the next awake window. Otherwise, in step 1012 the apparatus may enter non-empty queue contention (N-EQC) in order to transmit pending messages, and may then proceed to step 1008 where the apparatus enters one or more EQC state contentions. The quantity and/or duration of contentions in step 1008 may depend on, for example, whether messages were previously transmitted by the apparatus.

Provided that an initial beacon signal was successfully sent in step 1014, a further determination may then be made in step 1016 as to whether the apparatus has entered a period of time after which all received beacons are deemed late. For example, a determination may be made as to whether the time set for Tlate_beacon has passed as counted from the initial TBTT in the current awake window. If in step 1016 it is determined that the late beacon period has not yet begun, then in step 1018 the apparatus may determine whether there are messages pending in the apparatus for transmission. If it is determined that there are no messages pending in step 1018, the apparatus may engage in one or more EQC contentions in step 1020. If it is determined that messages are pending in step 1018, the apparatus may enter N-EQC state contention in step 1022 until access is granted to communicate. After the pending messages are sent in step 1020, the apparatus may again enter EQC state contention in step 1020 until the late beacon period begins.

When the late beacon period has commenced as determined in step 1016, the process may move to step 1024 where a further determination may be made as to whether the apparatus has received a late beacon. If no beacon has been received then the process may move to step 1026 where a determination may be made as to whether the current awake window is over. If the awake window is complete then in step 1028 the process may end and return to step 1000 in order to prepare for the next awake window. Otherwise, the process may return to step 1018 (designated “A” in FIG. 10) in order for contention (and possibly message transmission) to continue. In accordance with at least one embodiment of the present invention, the receipt of a late beacon signal may interrupt an ongoing contention period (e.g., began in step 1020 or 1022). However, other example implementations may allow the contention period to conclude, and the pending messages to be sent, before transmitting any additional beacon signals. If in step 1024 a late beacon is received, then in step 1030 a further determination may be made as to whether there are still messages pending for transmission from the apparatus. If no messages are pending in the apparatus, then in step 1032 an additional beacon signal may be transmitted. The process may then terminate in step 1028 and return to step 1000 to prepare for the next awake window.

Otherwise, if messages are determined to be pending in step 1030, then in step 1034 one of the contention, beacon, message strategies that were discussed in accordance with at least one of the various embodiments of the present invention may be employed to transmit the additional beacon signal and the pending messages. For example, options may exist to transmit an additional beacon signal before or after messages that are already pending in the apparatus. The additional beacon signal may be transmitted during the same TXOP as pending messages, or optionally separate contention periods may be employed to transmit the additional beacon signal and pending messages. Regardless of the particular configuration that is used, the process may then terminate in step 1028 and return to step 1000 to prepare for the next awake window.

Further to the above, the various example embodiments of the present invention are not strictly limited to the above implementations, and thus, other configurations are possible.

For example, apparatuses in accordance with at least one embodiment of the present invention may comprise means for transmitting a beacon signal during a periodic time interval in which communication is permitted in the wireless network, means for receiving a late beacon signal in the apparatus, the beacon signal being deemed late due to being received after a certain time measured from the beginning of the periodic time interval, and means for, in response to receiving the late beacon signal, initiating transmission of an additional beacon signal.

At least one other example embodiment of the present invention may include electronic signals that cause apparatuses to transmit a beacon signal from an apparatus during a periodic time interval in which communication is permitted in the wireless network, receive a late beacon signal in the apparatus, the beacon signal being deemed late due to being received after a certain time measured from the beginning of the periodic time interval, and in response to receiving the late beacon signal, initiate transmission of an additional beacon signal.

Moreover, example criteria that may trigger transmission of an additional beacon may comprise, but is not limited to, receiving a beacon containing a timestamp value indicating that the apparatus that transmitted the beacon is in risk of dropping out of synchrony with the network (e.g., the TSF time in the receiving apparatus at the time a beacon was received−timestamp of the received beacon>a difference that may cause synchronization to be lost).

Another example scenario that may trigger transmission of an additional beacon is when a received beacon does not cause a receiving apparatus to adjust its own TSF timing (e.g., the TSF time in the receiving apparatus at the time the beacon was received≧timestamp of the received beacon, so that the apparatus that transmitted the beacon appears to be running behind).

Accordingly, it will be apparent to persons skilled in the relevant art that various changes in forma and detail can be made therein without departing from the spirit and scope of the invention. The breadth and scope of the present invention should not be limited by any of the above-described exemplary embodiments, but should be defined only in accordance with the following claims and their equivalents.

What is claimed:

1. A method, comprising:
transmitting a beacon signal from an apparatus during a periodic time interval in which communication is permitted in the wireless network;
receiving a late beacon signal in the apparatus, the beacon signal being deemed late due to being received after a certain time measured from the beginning of the periodic time interval; and
in response to receiving the late beacon signal, initiating transmission of an additional beacon signal.

2. The method of claim 1, wherein the apparatus participates in access contention with other apparatuses in the wireless network in order to transmit the beacon signal.

3. The method of claim 2, wherein the apparatus participates in further access contention with other apparatuses in the wireless network in order to transmit pending messages.

4. The method of claim 3, wherein if the apparatus is participating in access contention for the pending messages when the late beacon signal is received, the access contention is interrupted in favor of access contention for transmitting the additional beacon signal and the interrupted access contention for the pending messages is resumed after the additional beacon signal is transmitted.

5. The method of claim 3, wherein both the pending messages and the additional beacon signal are transmitted at the end of the access contention for the pending messages.

6. The method of claim 1, wherein the additional beacon signal comprises connectivity information usable by other apparatuses for synchronizing timing to the network.

7. A computer program product comprising computer executable program code recorded on a computer readable storage medium, the computer executable program code comprising:
code configured to cause an apparatus to transmit a beacon signal from an apparatus during a periodic time interval in which communication is permitted in the wireless network;
code configured to cause an apparatus to receive a late beacon signal in the apparatus, the beacon signal being deemed late due to being received after a certain time measured from the beginning of the periodic time interval; and
code configured to, in response to receiving the late beacon signal, cause an apparatus initiate transmission of an additional beacon signal.

8. The computer program product of claim 7, further comprising code configured to cause the apparatus to participate in access contention with other apparatuses in the wireless network in order to transmit the beacon signal.

9. The computer program product of claim 8, further comprising code configured to cause the apparatus to participate in further access contention with other apparatuses in the wireless network in order to transmit pending messages.

10. The computer program product of claim 9, wherein if the apparatus is participating in access contention for the pending messages when the late beacon signal is received, the access contention is interrupted in favor of access contention for transmitting the additional beacon signal and the interrupted access contention for the pending messages is resumed after the additional beacon signal is transmitted.

11. The computer program product of claim 9, wherein both the pending messages and the additional beacon signal are transmitted at the end of the access contention for the pending messages.

12. The computer program product of claim 7, wherein the additional beacon signal comprises connectivity information usable by other apparatuses for synchronizing timing to the network.

13. An apparatus, comprising:
at least one processor; and
at least one memory including executable instructions, the at least one memory and the executable instructions being configured to, in cooperation with the at least one processor, cause the device to perform at least the following:
transmit a beacon signal during a periodic time interval in which communication is permitted in the wireless network;
receive a late beacon signal in the apparatus, the beacon signal being deemed late due to being received after a certain time measured from the beginning of the periodic time interval; and
in response to receiving the late beacon signal, initiate transmission of an additional beacon signal.

14. The apparatus of claim 13, wherein the apparatus participates in access contention with other apparatuses in the wireless network in order to transmit the beacon signal.

15. The apparatus of claim 14, wherein the apparatus participates in further access contention with other apparatuses in the wireless network in order to transmit pending messages.

16. The apparatus of claim 15, wherein if the apparatus is participating in access contention for the pending messages when the late beacon signal is received, the access contention is interrupted in favor of access contention for transmitting the additional beacon signal and the interrupted access contention for the pending messages is resumed after the additional beacon signal is transmitted.

17. The apparatus of claim 15, wherein both the pending messages and the additional beacon signal are transmitted at the end of the access contention for the pending messages.

18. The apparatus of claim 13, wherein the additional beacon signal comprises connectivity information usable by other apparatuses for synchronizing timing to the network.
